(19) United States
(12) Patent Application Publication
(10) Pub. No.: US 2006/0141835 A1
(43) Pub. Date: Jun. 29, 2006

(54) Connecting lead for a probe

(76) Inventors: Helmut Weyl, Wiesbaden (DE); Andreas Pesch, Krefeld (DE); Hermann Brauer, Barssel (DE); Tanil Gezgin, Ovelgonne (DE); Horst Kontants, Oldenburg (DE); Mark Knoetig, Nordenham (DE)

Correspondence Address: KENYON & KENYON LLP, ONE BROADWAY, NEW YORK, NY, 10004, US

(21) Appl. No.: 10/536,371

(22) PCT Filed: Nov. 25, 2003
(86) PCT No.: PCT/DE03/03903

§ 371 Date: Feb. 27, 2006

(30) Foreign Application Priority Data
Nov. 25, 2002 (DE) 102 54 849.8

(51) Int. Cl. H01R 4/60

(52) U.S. Cl. 439/210

(57) ABSTRACT

Described is a connecting line for a measuring sensor, in particular for a measuring sensor for determining a physical property of a gas to be measured, such as the temperature or the oxygen concentration in the exhaust gas of internal combustion engines, including a jacket tube, at least two electrical conductors disposed in the jacket tube and further including insulating means which electrically insulate the electrical conductors from each other and from the jacket tube. In order to use unsheathed, bare metal wires as electrical conductors and to prevent short-circuits between the conductor and the jacket tube, as well as to ensure the flexibility of the jacket tube during installation, the insulating means include a plurality of insulating members which are centrally supported on each other and contain at least two through-holes for passage of the electrical conductors; the central supports being designed in the manner of a ball-and-socket joint so as to allow the insulating members to tilt with respect to each other around the supports.

### FIELD OF THE INVENTION

The present invention is based on a connecting line for a measuring sensor, in particular for a measuring sensor for determining a physical property of a gas to be measured, especially for determining the oxygen concentration or the temperature in the exhaust gas of internal combustion engines.

### BACKGROUND INFORMATION

When installing measuring sensors which are used as exhaust gas lambda sensors in the exhaust connectors of internal combustion engines, the jacket tube is bent substantially at a right angle to allow the connecting line to be contacted, i.e., to be connected to the electrical system of the motor vehicle. To reliably protect the electrical conductors from short-circuit, the electrical conductors are electrically isolated from each other and from the jacket tube.

In a known connecting line for a measuring sensor of this type (German Patent No. 195 23 911), the electrical conductors are sheathed with a high-strength, electrical insulation, such as fiber glass; and the jacket tube, which is made of a temperature-resistant metal, such as CrNi— or NiCr alloys, accommodates four or five sheathed electrical conductors packed with the greatest possible density. At the terminal end, the electrical conductors are welded to crimp barrels in which the ends of connection cables leading to a plug connector are crimped. The crimp barrels, together with one end of the jacket tube and the end region of the connection cables, are surrounded by a molded sealing element, for example, of PTFE. To allow damage-free bending of the jacket tube, care must be taken that the sheathed electrical conductors have enough play inside the jacket tube in order for the changes of length occurring in the electrical conductors during the bending of the jacket tube to be compensated for within the jacket tube.

In another known, heat-resistant connecting line for an exhaust gas lambda sensor (European Published Patent Application No. 0 843 321), a pair of bare electrical conductors made of nickel wire and a pair of ventilation tubes made of stainless steel are disposed inside the jacket tube of stainless steel. The electrical insulation is composed of magnesium powder filled into the jacket tube in such a manner that the two pairs of electrical conductors and ventilation tubes are positioned diametrically opposite each other at the four corners of a square, and are completely insulated from each other and from the jacket tube by the magnesium powder. Such a connecting line cannot be bent during installation.

### SUMMARY OF THE INVENTION

The connecting line according to the present invention has the advantage that the insulating members hold the electrical conductors at a defined distance from each other and from the jacket tube, thereby making it possible to use bare wires as electrical conductors without a sheathing made of high-temperature resistant material, which is very expensive to produce. The connecting line can be produced in a very simple and economical manner because the insulating members only have to be strung onto the conductors, after which the string-on unit can be easily inserted into the jacket tube.

Since, according to the present invention, the individual insulating members are supported centrally and able to tilt with respect to each other about the central support, the adjacent insulating members, in their entirety, form a kind of a “spine” which can be bent in all directions. This allows the jacket tube to be bent as desired and to be easily adapted to the specific installation conditions in the vehicle. This is of considerable importance because the measuring sensor must be installed such that the sensing element is in a predetermined rotational position relative to the axis of the exhaust pipe, and because the options for routing the connecting line to the measuring sensor in the engine compartment of the motor vehicle are very limited.

According to a preferred embodiment of the present invention, the central supports between the insulating members are designed in the manner of a ball-and-socket joint. To increase the mechanical stability, in particular against vibrations, a spring wire, preferably a chrome steel spring, is passed centrally through the adjacent insulating members, for which purpose each insulating member has a central hole extending through the support, and the spring wire is passed through the aligned central openings of the insulating members in such a manner that it fits accurately therein. If necessary, the spring wire can additionally be used as an electrical conductor or be omitted if there is less dynamic stress.

In one preferred embodiment of the present invention, in successive insulating members, each electrical conductor is passed through a through-hole that is offset by a rotation angle from the through-hole in the preceding insulating member; the total rotation angle offset from the first to the last insulating member being equal to or greater than 360°. In this manner, the conductor passed through the entirety of insulating members takes a helical path around the axis of the “spine” formed by the insulating members. This helical path of the electrical conductors along the length of the jacket tube allows the electrical conductors to change in length during omnidirectional bending of the jacket pipe, thereby preventing the exertion of tensile forces on the ends of the electrical conductors protruding at both ends of the jacket tube. At the same time, in conjunction with the through-holes, which are in the form of elongated slots, the conductors are restrained between the disks in such a manner that lateral movement of the conductors is prevented and the vibration resistance of the connecting line is increased.

In accordance with an advantageous embodiment of the present invention, in order to fix rotated positions of the individual insulating members relative to one another, latching means are provided between neighboring insulating members. When engaged, the latching means block relative rotation of the insulating members. The latching means can be disengaged by axially withdrawing the insulating members from each other.

In one advantageous embodiment of the present invention, the latching means include at least one axially protruding latching pin formed on each insulating member and a plurality of latching holes which are arranged on each insulating member equidistantly on a pitch circle concentric with the axis of the insulating member, and which are used to receive the latching pin in a form locking manner. The latching pin and the plurality of latching holes are located on faces of the insulating member facing away from each other, so that in each case the latching pin of one insulating member is able to engage a latching hole of the neighboring insulating member. Preferably, each insulating member is provided with a number of latching pins corresponding to the number of latching holes.

Once all insulating members 15 are latched to each other in proper relation in order to produce the helical path of the electrical conductors, then, according to an advantageous embodiment of the present invention, the two outer of the insulating members, which are centrally supported on each other, are axially braced in the jacket tube. Because the latching means are braced in the axial direction, they are securely held in engagement, thereby reliably preventing the insulating member from subsequently rotating relative to each other.

In accordance with an advantageous embodiment of the present invention, the two outer insulating members are supported at one end of the jacket tube by a sealing member which is made of electrically insulating material and is pressed into the jacket tube, and at the other end of the jacket tube by an insulating adapter which adapts the spatial orientation of the electrical conductors inside the jacket tube, which is determined by the position of the through-holes in the insulating members, to a desired contact pattern of the ends of the electrical conductors protruding from the jacket tube.

### BRIEF DESCRIPTION OF THE DRAWINGS

FIG. 1 is a side view of a connecting line for a measuring sensor after final assembly.

FIG. 2 is a perspective view of an insulating member in the connecting line of FIG. 1.

FIG. 3 is a plan view of the connecting member in the direction III in FIG. 2.

FIG. 4 is a side view of an insulating adapter in the connecting line of FIG. 1.

FIG. 5 is a plan view of the insulating adapter in the direction of arrow V in FIG. 4.

FIG. 6 is a perspective view of the insulating adapter of FIGS. 4 and 5.

FIG. 7 is a side view of an end plate in the connecting line of FIG. 1.

FIG. 8 is a plan view of the end plate in the direction VIII in FIG. 7.

FIG. 9 is a perspective view of the end plate of FIGS. 7 and 8.

FIG. 10 is a side view of the connecting line of FIG. 1 without the jacket tube after insulating members, insulating adapter, and end plates are strung onto the electrical conductors.

FIG. 11 shows the connecting line of FIG. 10 after the insulating members are rotated relative to each other;

FIG. 12 an enlarged view of the detail XII in FIG. 11.

FIG. 13 is a partial side view of the connecting line of FIG. 1 with a modified end at the terminal end.

### DETAILED DESCRIPTION

FIG. 1 is a side view of a connecting line for a measuring sensor, in particular for a measuring sensor for determining a physical property of a gas to be measured, such as the temperature or the oxygen concentration in the exhaust gas of internal combustion engines of motor vehicles; the connecting line allowing a sensing element (not shown here), which forms part of the measuring sensor and is exposed to the gas to be measured, to be connected to a plug connector (not shown here) for connecting the measuring sensor to a control unit in the electrical system of the motor vehicle. The connecting line has a jacket tube 13 made of high-temperature resistant material and electrical conductors 14 (in the exemplary embodiment, a maximum of five electrical conductors 14) which are disposed inside jacket tube 13 between a sensor end 131 and a terminal end 132 of jacket tube 13 and which protrude from jacket tube 13 at sensor end 131 for contacting the sensing element. Electrical conductors 14 take the form of bare, high-temperature resistant wires, such as nickel wires.

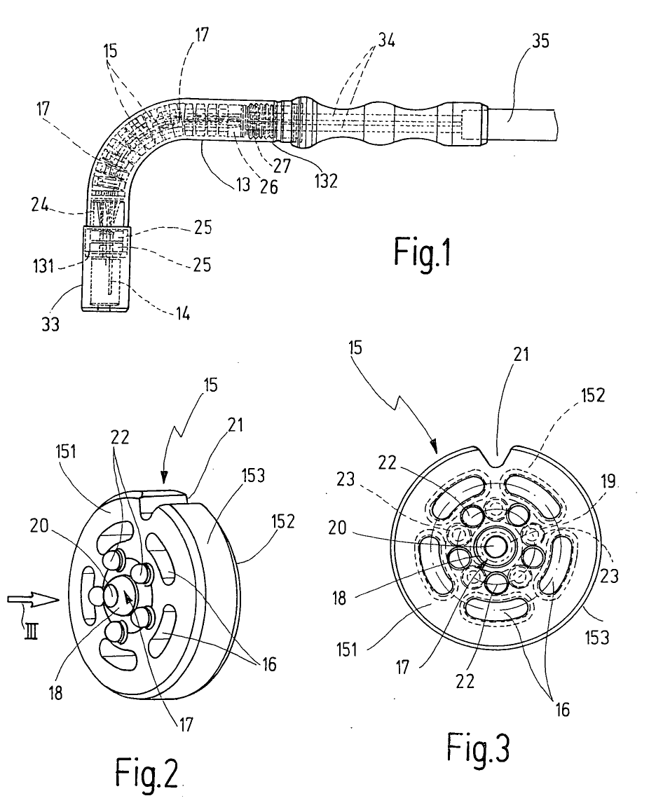

To prevent short-circuits between electrical conductors 14 on the one hand and, on the other hand, between electrical conductors 14 and jacket tube 13, electrical conductors 14 are held in insulating means which prevent electrical conductors 14 from contacting each other or from contacting jacket tube 13 when bending jacket tube 13 during installation, as is shown in FIG. 1. To this end, there are provided a plurality of insulating members 15 which are made of high-strength plastic, such as thermosetting plastic, or a ceramic, and are supported on each other and which, in the exemplary embodiment, take the form of circular insulating disks, but may also have a different geometric shape. Insulating members 15 are centrally supported on each other and with their peripheral surfaces 153 on the inner wall of jacket tube 13. Insulating members 15 are provided with through-holes 16 (FIGS. 2 and 3) through which are passed electrical conductors 14, as shown by broken lines in FIG. 1. The central supports 17 of insulating members 15 are designed to allow insulating members 15 to tilt with respect to each other in all directions around supports 17. To this end, supports 17 are designed in the manner of a ball-and-socket joint by providing each insulating member 15, on faces 151, 152 facing away from each other, with a convex bulge 18 protruding above face 151 and a concave depression 19 receding behind face 152. Bulges and depressions 18, 19 are configured in the manner of a spherical shell such that in adjacent insulating members 15, a convex bulge 18 of one insulating member 15 rests in a concave depression 19 of neighboring insulating member 15 in such a way that there is a clearance between facing faces 151, 152 of the neighboring insulating members 15. As can be seen in FIG. 1, and better in FIGS. 11 and 12, adjacent insulating members 15, in their entirety, form a kind of a “spine” which can be bent to all sides and in all directions, as illustrated by way of example in FIG. 1. Since the individual insulating members 15 are supported at the edge on jacked tube 13, the bending shape of jacket tube 13 determines the shape of the “spine”. To increase the mechanical stability of the “spine”, in particular against vibrations, a spring wire, such as a chrome steel spring, is passed centrally through the individual insulating members 15, for which purpose the insulating members each have a central bore 20 extending through bulge 18 and depression 19; the spring wire (not shown here) being passed through the central bore in such a manner that it fits accurately therein. If necessary, this spring wire can be used as an additional electrical conductor 14. Preferably, the spring wire is made of steel alloyed with chromium (Cr); chromium, nickel (Cr Ni); chromium, nickel, molybdenum (Cr Ni Mo); or chromium, nickel, aluminum (Cr Ni Al).

All insulating members are identical in design and are configured as shown in FIGS. 2 and 3. The total of five 5 through-holes 16 for passage of a maximum of five electrical conductors 14 are arranged equidistantly on a pitch circle concentric with the axis of insulating member 15 and are shaped as elongated slots to allow the insulating members 15 to be rotated relative to each other after electrical conductors 14 are passed through the initially aligned through-holes 16. Such a rotation of successive insulating members 15 about their own axis or about the central spring wire relative to the respective preceding insulating member 15 in the direction of assembly prevents electrical conductors 14 from being extended or compressed during the bending of the “spine”. If all n existing insulating members 15 are rotated by an angle 360°/n with respect to each other, then each of conductors 14 passed through through-holes 16 follows a path in the form of a 360° twisting helix. If a greater angle of rotation is selected, then electrical conductors 14 are given several complete or incomplete helical turns. In the process, electrical conductors 14 are restrained between the individual insulating members 15 in such a manner that conductors 14 are prevented from moving, thereby increasing the stability of the “spine” against vibrations. For rotation of the individual insulating members 15, each insulating member 15 is provided on its peripheral surface 151 with a groove-like notch 21 into which an assembly tool can be inserted to rotate insulating member 15.

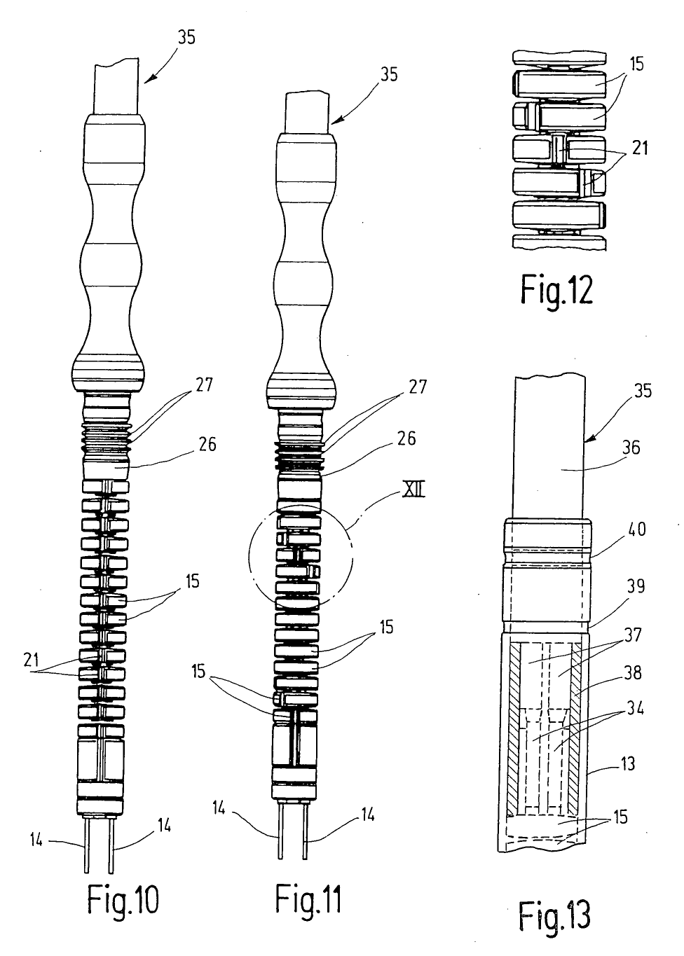

In FIG. 10, insulating members 15 are shown supported on each other and strung on electrical conductors 14 whereby through-holes 16 are substantially aligned with one another in five parallel rows. Consequently, notches 21 in insulating members 15 are also in alignment. In FIG. 11 and in the enlarged partial view of FIG. 12, insulating members 15 are shown rotated by a predetermined rotation angle. From notches 21, which are rotated relative to each other, it can be seen that each insulating member 15 is rotated with respect to the preceding insulating member 15 by the same rotation angle.

To fix the rotation performed by insulating members 15, latching means are provided between neighboring insulating members 15. When engaged, the latching means block relative rotation of insulating members 15 with respect to each other. The latching means can be disengaged by axially withdrawing insulating members 15 from each other. These latching means include latching pins 22 and latching holes 23 to receive latching pins 22; the latching pins 22 engaging latching holes 23 with a certain amount of play so as not to hinder insulating members 15 from tilting with respect to each other. As can be seen in FIGS. 2 and 3, each insulating member 15 is provided on one face 151 with axially protruding latching pins 22 (five in the exemplary embodiment), which are arranged equidistantly on a pitch circle concentric with the axis of insulating member 15 and, on the other face 152 facing away therefrom (FIG. 3), with an equal number of latching holes 23, which are also arranged equidistantly on a pitch circle having the same radius as the pitch circle of latching pins 22.

When the insulating members 15 strung on electrical conductors 14 are placed against one another, then latching pins 22 of one insulating member 15 axially engage latching holes 23 of the neighboring insulating member 15. Therefore, to rotate insulating members 15, two neighboring insulating members 15 must always first be axially separated from each other to the point where latching pins 22 are removed from latching holes 23, then, one insulating member 15 must be rotated by the desired rotation angle, after which both insulating members 15 are pressed against one another again, thereby engaging latching pins 22 into latching holes 23 and preventing insulating members 15 from rotating back, for example, under the tension of electrical conductors 14. Once the “spine” is completed with all insulating members 15, it is axially restrained, as will be explained hereinafter, so that the latching means remain effective, reliably fixing a previously adjusted rotational position of the individual insulating members 15.

In principle, it is sufficient for each insulating member 15 to have only one latching pin 22 formed thereon which can be inserted into one of latching holes 23 of the neighboring insulating member 15 in accordance with the rotation of insulating member 15. The number of available latching holes 23 is arbitrary and depends on the spatial conditions on insulating member 15 and on the desired minimum rotation angle between two neighboring insulating members 15.

For the previously mentioned axially bracing of the “spine” in jacket tube 13 with the insulating members 15 rotated relative to each other, a cylindrical insulating adapter 24 and two adjacent end plates 25 are disposed at sensor end 131 of jacket tube 13, that is, in the portion of jacket tube 13 that is not bent during installation, but remains straight; jacket tube 13 being crimped onto outer end plate 25. Insulating adapter 24 and the two end plates 25 are also made of high-strength plastic, such as thermosetting plastic, or of a ceramic. At terminal end 132 of jacket tube 13, axial support is provided by a sealing member 26 which is pressed into jacket tube 13. This sealing member 26 is provided with axially spaced apart sealing lips which extend circumferentially around the periphery thereof and are pressed against the inner wall of jacket tube 13, thereby providing an adequate seal.

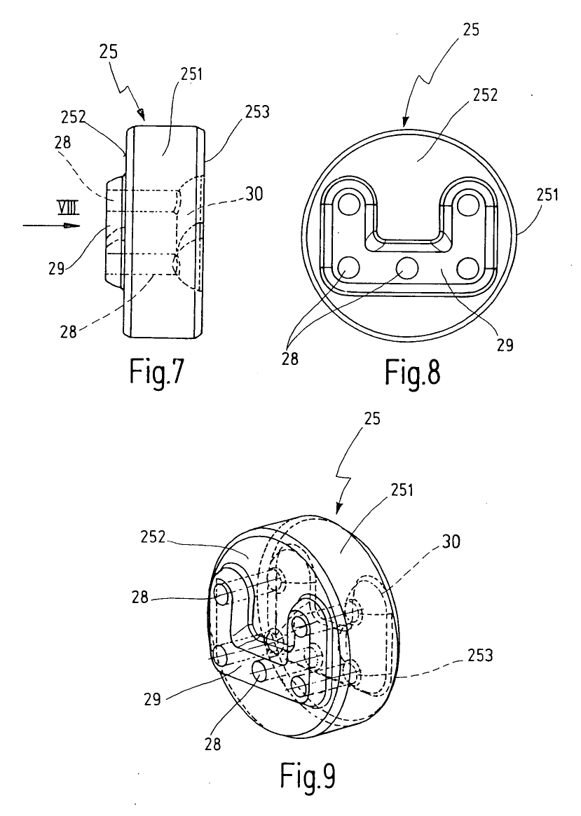

One of the two end plates 25 is shown in an enlarged view in FIGS. 7 through 9. The end plate is circular and is supported with its peripheral surface 251 on the inner wall of jacket tube 13. In accordance with the number of through-holes 16 provided in insulating members 15, the end plate has five through-holes 28 which are arranged according to the connection pattern of electrical conductors 14, which is determined by the sensing element. In the exemplary embodiment of FIGS. 7 through 9, the connection pattern is more or less in the shape of a U with three through-holes 28 located in the cross-piece of the U and one through-hole 28 located in each leg of the U. A different connection pattern is, of course, also possible, for example, by arranging three through-holes 28 on one of two parallel lines which are equally spaced from the diameter line. Faces 252 and 253 of end plate 25 are parallel to each other and substantially flat; face 252 being provided with a bulge 29 and face 253 having a corresponding indentation 30; the bulges and indentations surrounding the openings of through-holes 28. Bulge 29 and indentation 30 are shaped such that the bulge 29 of one end plate 22 engages the indentation 30 of the other end plate 22 in a substantially form-locking manner as a result of which the two end plates 22 rest non-rotatably against one another.

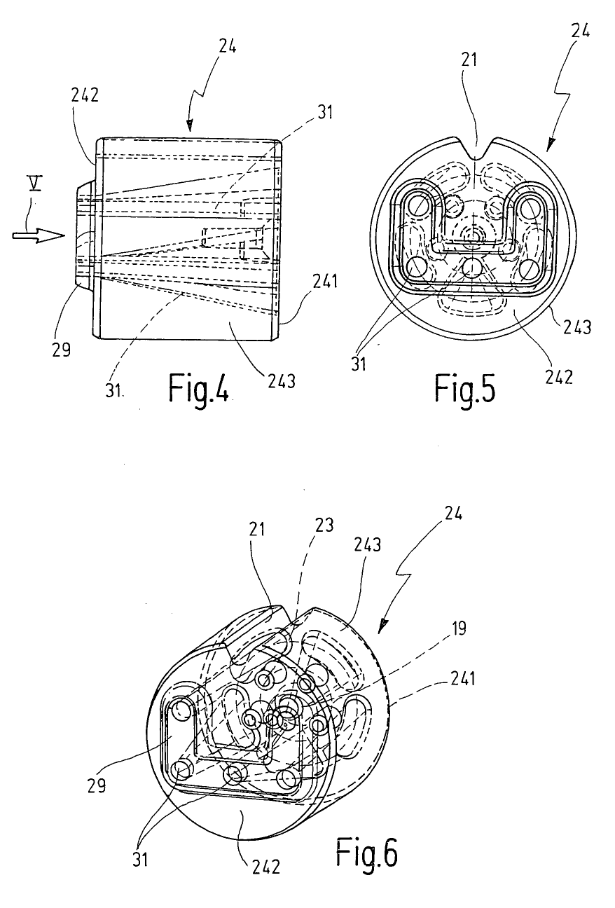

Insulating adapter 24 is shown in FIGS. 4 through 6. Via the insulating adapter, electrical conductors 14 disposed in insulating members 15 are formed into the connection pattern determined by end pates 22 for the conductor ends protruding from jacket tube 13. To this end, through-passages 31 are provided in insulating adapter 24 in such a way that, on the one hand, their openings in face 241, which faces insulating members 15, are congruent with the slotted through-holes 16 in insulating members 15 and, on the other hand, their openings in face 242, which faces an end plate 25, are congruent with the openings of through-holes 28 in the facing face 252 of end plate 25. The one openings of through-passages 31 in turn are located in a bulge 32 formed on face 242; the bulge being able to engage indentation 30 on face 253 of adjacent end plate 25 in a form-locking manner. Face 241, which contains the slotted openings of through-passages 31, of insulating adapter 24 is provided with the same latching holes 23 as insulating members 14, thus allowing latching pins 22 of adjacent insulating member 15 to engage these latching holes 23. In addition, a depression 19 identical to that in insulating members 15 is provided centrally in face 241; the corresponding bulge 18 of neighboring insulating member 15 resting in the depression to form a support 17, thus allowing insulating member 15 to be tilted with respect to insulating adapter 24. Just as insulating members 15, insulating adapter 24 can be provided with an end section 21 on its peripheral surface 243.

During assembly of the connecting line, the (maximum of five) individual electrical conductors 14 are strung through the aligned through-holes 16 arranged in five parallel rows in insulating members 15, through through-passages 31 in insulating adapter 24, and through through-holes 28 in the two end plates 25; all groove-like notches 21 in successive insulating members 15 preferably being aligned with one another (FIG. 10). Thereafter, the individual insulating members 15 are successively rotated by a predetermined rotation angle using an assembly tool which can be inserted into notches 21. In the process, two previously neighboring insulating members 15 are axially withdrawn from each other to disengage the latching means, and then pushed together axially to activate the latching means (FIGS. 11 and 12). The ends of conductors 14 at the terminal end are connected to the flexible leads 35 of a connection cable 35 by ultra welding and surrounded by molded sealing member 26. The unit so assembled, such as is shown in FIG. 11, is inserted into jacket tube 13. Sealing member 26 is pressed into jacket tube 13 at the terminal end thereof, after which jacket tube 13 is rolled in this region, thereby creating an form-locking and frictional connection between jacket tube 13 and sealing member 26. At the sensor end of jacket tube 13, the edge thereof is crimped onto outer end plate 22. Alternatively, jacket tube 13 may be provided at the end with reevings which are laid on the outer end plate 22. For protection in transit, a protective cap 33 (shown in FIG. 1) is pushed onto sensor end 131 of jacket tube 13 to protect the protruding ends of electrical conductors 14 from damage.

During installation of the measuring sensor, the connecting line is bent at an angle according to the space requirements in the engine compartment, such as is illustrated in FIG. 1. This bending is made possible by the “spine-like nature” of the adjacent insulating members 15, because the insulating members can be bent in all directions around their central supports 17. The helical path given to the electrical conductors 14 by the described relative rotation of insulating members 15 with respect to each other allows electrical conductors 14 to change in length in the bend area of the connecting line, thereby preventing the protruding conductor ends from changing in length or position in the areas where electrical conductors 14 enter or emerge from jacket tube 13 of the connecting line, and preventing tensile forces from being exerted on the connection regions formed by the protruding conductor ends during the bending of the connecting line.

In FIG. 13, the above-described connecting line is shown with a modified end region at the terminal end, where connection cable 34 is inserted into jacket tube 13. Unlike the connecting line described with reference to FIGS. 1 through 12, sealing member 26 is omitted. Outer insulating member 15 is axially supported by a hollow cylindrical spacer 38 which is made of electrically insulating material and is axially immovably fixed in jacket tube 13 by connection cable 35 inserted into the sheath 36 of connection cable 35 surrounding flexible leads 34, which are in turn covered by an insulation 37, is brought up to spacer 38, thereby allowing spacer 38 to support itself axially end of jacket tube 13. The connecting points between electrical conductors 14 and flexible leads 34 of connection cable 35 are disposed inside hollow cylindrical spacer 38, while an outer on outer sheath 36. Outer sheath 36 is made of an elastically or plastically deformable plastic, preferably of silicone. Connection cable 35 is axially immovably fixed in jacket tube 13 and sealed against jacket tube 13. To this end, two circumferential beads are formed outwardly in jacket tube 13 and inwardly in outer sheath 36 of connection cable 35 by rolling jacket tube 13. A first bead 39 is located in the immediate vicinity of spacer 38, and a second bead 40 is situated close to the free end of jacket tube 13.

1-24. (canceled)

25. A connecting line for a measuring sensor for determining a physical property of a gas to be measured, comprising:
a jacket tube;
at least two electrical conductors disposed in the jacket tube;
an insulating arrangement that electrically insulates the at least two electrical conductors from each other and from the jacket tube; and
central supports, wherein:
the insulating arrangement includes a plurality of insulating members that are centrally supported on each other and contain at least two through-holes through each of which is passed at least one of the at least two electrical conductors, and
the central supports allow the insulating members to tilt with respect to each other in all directions around the central supports.

26. The connecting line as recited in claim 25, wherein the measuring sensor determines one of an oxygen concentration and a temperature in an exhaust gas of an internal combustion engine.

27. The connecting line as recited in claim 25, wherein the central supports include ball-and-socket joints.

28. The connecting line as recited in claim 25, further comprising:
a spring wire, wherein each insulating member is provided with a central hole extending through an associated one of the central supports, and wherein the spring wire is passed through the aligned central openings in the insulating members in such a manner that the spring wire fits accurately therein.

29. The connecting line as recited in claim 28, wherein:
each insulating member is provided, on faces facing away from each other, with a convex bulge protruding above a respective face and a concave depression receding behind the respective face,
the central supports each include a concave depression of an insulating member and a convex bulge, lying therein, of a neighboring insulating member, and
the bulge rests in the depression in such a way that there is a clearance between the facing faces of the neighboring insulating members.

30. The connecting line as recited in claim 25, wherein in successive insulating members, each electrical conductor is passed through a through-hole that is offset from the through-hole in the preceding insulating member by a rotation angle in the same direction of rotation.

31. The connecting line as recited in claim 30, wherein in each insulating member, the through-holes are arranged equidistantly on a pitch circle concentric with an axis of the insulating member, and wherein the rotation angle offset between the through-holes is constant in successive insulating members.

32. The connecting line as recited in claim 25, wherein the through-holes include elongated slots.

33. The connecting line as recited in claim 25, wherein each insulating member is provided on its peripheral surface with a groove-like notch for insertion of an assembly tool.

34. The connecting line as recited in claim 25, further comprising:
a latching arrangement provided between neighboring insulating members, wherein, when engaged, the latching arrangement blocks relative rotation of the insulating members with respect to each other, and wherein the latching arrangement can be disengaged by axially withdrawing the insulating members from each other.

35. The connecting line as recited in claim 34, wherein the latching arrangement includes at least one axially protruding latching pin formed on each insulating member and a plurality of latching holes which are arranged on each insulating member equidistantly on a pitch circle concentric with the axis of the insulating member, and which are used to receive the at least one latching pin in a form locking manner, and wherein the at least one latching pin and the plurality of latching hole's are located on faces of the insulating member facing away from each other, so that in each case a latching pin of one insulating member is able to engage a latching hole of the neighboring insulating member.

36. The connecting line as recited in claim 35, wherein each insulating member is provided with a number of latching pins corresponding to the number of latching holes.

37. The connecting line as recited in claim 35, wherein in successive insulating members, a rotation angle offset between the through-holes surrounding the same electrical conductor is equivalent to an angular offset of the latching holes arranged on the pitch circle.

38. The connecting line as recited in claim 35, wherein the two outer of the insulating members, which are centrally supported on each other, are axially braced in the jacket tube.

39. The connecting line as recited in claim 38, further comprising:
a hollow cylindrical spacer made of an electrically insulating material inserted in the jacket tube, wherein:
one of the outer insulating members at one end of the jacket tube is axially supported by the hollow cylindrical spacer,
the hollow cylindrical spacer is supported axially by an outer sheath of a connection cable inserted into the end of the jacket tube, the outer sheath being made of a plastic.

40. The connecting line as recited in claim 39, wherein the plastic includes silicone.

41. The connecting line as recited in claim 40, wherein an end of the connection cable inserted into the jacket tube is axially and immovably fixed therein by rolling the jacket tube, thereby forming a seal.

42. The connecting line as recited in claim 25, further comprising:
an insulating adapter supported on the jacket tube, wherein the other of the outer insulating members at the other end of the jacket tube is axially supported by the insulating adapter.

43. The connecting line as recited in claim 42, further comprising:
at least one end plate made of an electrically insulating material and resting axially against the insulating adapter, wherein:
the at least one end plate is provided with through-holes are arranged according to a desired contact pattern of the ends of the at least two electrical conductors protruding from the jacket tube,
the other end of the jacket tube is closed by the at least one end plate,
the insulating adapter is provided with through-passages for passage of the at least electrical conductors, and
the through-passages provide a transition from the openings of the through-holes in the adjacent insulating member to the openings of the through-holes in the adjacent at least one end plate.

44. The connecting line as recited in claim 43, wherein the jacket tube one of is crimped onto the at least one end plate and is provided with reevings on which rests the at least one end plate.

45. The connecting line as recited in claim 39, wherein the at least two electrical conductors are each connected to a flexible lead of the connection cable by ultrasonic welding that produces connecting points, and wherein the connecting points are located inside the hollow cylindrical spacer.

46. The connecting line as recited in claim 42, wherein the insulating adapter is provided on its face facing the at least one end plate with a bulge protruding above the face of the insulating adapter, and wherein the at least one end plate is provided on its face facing the insulating adapter with an indentation receding behind the face facing the insulating adapter to form-lockingly receive the bulge on the insulating adapter.

47. The connecting line as recited in claim 42, wherein the insulating members, the insulating adapter, and the at least one end plate are made of one of a high-temperature resistant plastic and a ceramic.

48. The connecting line as recited in claim 47, wherein the high-temperature resistant plastic includes Duroplast.

49. The connecting line as recited in claim 25, wherein the insulating members include circular disks supported with their periphery in the jacket tube.

50. A method for installing a connecting line, comprising:
when through-holes of adjacent insulating members are in alignment with one another, passing each electrical conductor through a row of aligned through-holes; and
after the passing of each electrical conductor, rotating each of the insulating members, one after the other, in the same direction of rotation and axially inserting each insulating members with a latching pin into a latching hole of a neighboring insulating member.

51. The method as recited in claim 50, further comprising:
placing insulating members against one another in such a manner that groove-like notches of the insulating members are in alignment with one another, wherein the rotating of the insulating members is performed using an assembly tool which, in each case, can be inserted into a notch.
